(19) United States
(12) Patent Application Publication
(10) Pub. No.: US 2003/0192253 A1
(43) Pub. Date: Oct. 16, 2003

(54) UNDERGROUND GATE SYSTEM

(76) Inventors: Paul Miller, Indianapolis, IN (US); Charles Logsdon, Indianapolis, IN (US)

Correspondence Address: DANIEL O'CONNOR, 6720 BUCKHORN DR., #821, INDIANAPOLIS, IN, 46254, US

(21) Appl. No.: 10/122,790

(22) Filed: Apr. 16, 2002

(51) Int. Cl. E06B 11/00

(52) U.S. Cl. 49/49; 49/131

(57) ABSTRACT

An underground gate system for use with driveways and many other applications. The system includes plural posts which are hydraulically raised and lowered to blocking or open positions. In the up position, the posts stand 18-36 inches tall and include decorative lighting for safety and visibility. In the down position, the gate elements are virtually invisible. A particular hydraulic control system is also disclosed. The system is designed to be controlled from an in-car or in-house location.

### BACKGROUND AND OBJECTS OF THE INVENTION

The present invention is generally related to the gating and closure arts and, in particular, to a novel system and method for blocking a driveway.

Prior art systems in this area have included various chain or spike-type blocking means being driven by mechanical operators.

Such prior art systems have proven to be costly to manufacture and cumbersome to install in practical driveway uses.

Thus, driveway blocking systems have not heretofore found widespread use in the art.

Accordingly, it is an object of the present invention to set forth a novel driveway gating system which may be economically manufactured and easily installed in an existing driveway.

It is also an object of the invention to demonstrate a gating system with reliable and simplified actuator means for the gate elements.

It is a further object of the invention to show a driveway gating system having a pleasing appearance for widespread commercial appeal.

The system and method disclosed has beneficial uses for other roadway and parking garage systems and is not limited to driveway uses.

It is also an object of the invention to show a blocking system which may be automatically deactivated to prevent unwanted damage to a vehicle located over the system.

It is a still further object of the invention to set forth a gating system having novel remote control and camera viewing features.

These and other objects and advantages of the invention will be apparent to those of skill in the art from the description which follows.

### PRIOR ART PATENTS AND DESIGNS

During the course of preparing this patent specification for submission to the U.S. Patent and Trademark Office, a full search of the prior art was conducted.

U.S. Pat. No. 5,538,358 teaches a vehicle access control system using a ramp and multiple tines or spikes. The system uses numerous mechanical parts and is thus very costly to manufacture.

U.S. Pat. No. 5,815,983 uses a chain element to block a driveway. The chain is lowered into a gutter when not in use. The operating mechanisms for this design are very complex and thus subject to failure in practical usage.

The present invention has numerous advantages over the prior art and is believed to be clearly novel and patentable by reason of its underground location and the drive means described and other operating accessories specified herein.

### SUMMARY OF THE INVENTION

The system utilizes a plurality of posts or tubes which are raised to a height of 18-36 inches to block a driveway or perform other blocking functions.

The posts are placed underground and hydraulically raised to an upper position by means of a fluid which is initially contained in a reservoir.

In the down and stored position, the posts are designed to be virtually invisible by coating the tops thereof with a durable painted surface to match the color of the driveway.

The system includes pressure switch means to prevent damage to a vehicle over the top of the gate system.

A remote control operation with variable access codes may be used with the system.

The posts may vary in diameter depending on the particular application. The posts may be used in outdoor or indoor locations and may be driven by air or other equivalent means. A single post may be utilized to perform the blocking function.

### BRIEF DESCRIPTION OF THE DRAWING FIGURES

FIG. 1 is a side schematic view of the posts used to block a driveway and illustrates the operating system utilized to raise the posts to an upper or blocking position.

FIG. 2 is a top schematic view of the system and illustrates the ground-level flange elements used-in conjunction with the blocking posts. FIG. 2 also shows other accessories which may be beneficially used with the gate system.

FIG. 3 is an enlarged view of the ground-level flange and seal elements which are used in combination with the blocking posts.

### FULL DESCRIPTION OF A PREFERRED EMBODIMENT

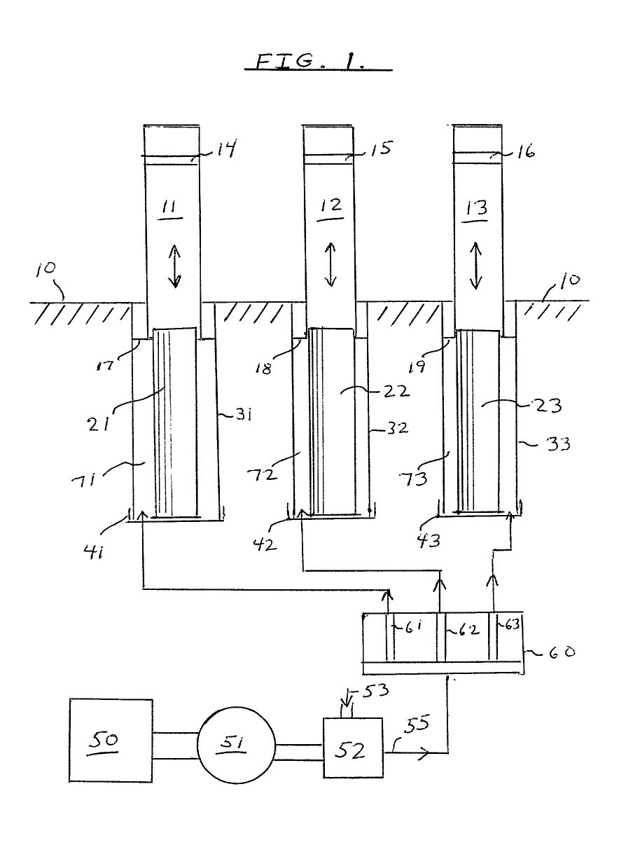

Referring to FIG. 1, a driveway 10 is shown as being blocked by means of three posts 11, 12, and 13 which have been raised to the blocking position shown.

For safety and decorative reasons, the blocking posts have light rings 14, 15 and 16 formed thereon.

As further indicated in FIG. 1, the posts have been driven to an upper blocking position by a lower hydraulic system which includes a reservoir 50, a hydraulic pump 51 and a control valve 52. The control valve 52 includes a supply port 55 and a return port 53.

Fluid supplied from the control valve is passed through a hydraulic splitter valve 60 which has lines 61, 62 and 63 formed therein.

The lower portions of the posts include flange elements 17, 18 and 19. The posts are thus moved up and down along lower cylinders 21, 22 and 23 which are contained within outer casings 31, 32 and 33.

The lower portions of the post assemblies further bottom caps 41, 42 and 43.

The combined caps, casing and flange elements shown result in hydraulic fluid areas 71, 72 and 73 being formed in the lower post assemblies.

Thus, when fluid is pumped from lines 61, 62 and 63 into chambers 71, 72 and 73, the posts are raised in synchronized fashion to the upper blocking position. To lower the posts to an unblocking position, fluid may be withdrawn from the chambers 71, 72 and 73 and returned to the control valve via the return line 53.

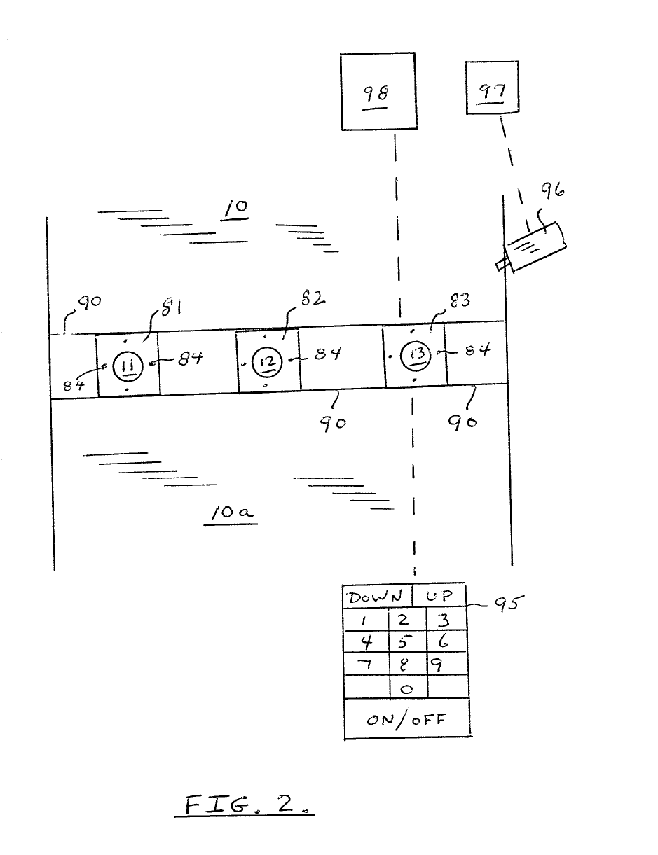

In the top view of FIG. 2, the posts are shown in a lowered or unblocking position and further advantageous features of the design are indicated.

In FIG. 2, the driveway 10 ia again shown. Driveway 10 has an entrance area 10a which may be blocked by posts. Upper flanges 81, 82 and 83 are at ground level.

As further shown in FIG. 2, the ground-level flanges 81-83 are secured to the driveway surface by plural bolts 84.

Pressure switch elements 90 are positoned to detect the presence of a vehicle over the area of the posts 11-13. The pressure switch elements are designed to override the post-raising function of the system. Thus, damage to a vehicle stopped over the posts is prevented.

An in-car remote transmitter is indicated at numeral 95. The transmitter controls operation of the hydraulic pump and control valve to raise or lower the blocking posts 11-13.

The keypad on remote control 95 may be used to admit various approved persons into the driveway by utilizing an assigned code number.

The system may also include a camera 96 and an in-house receiver 97 to view the camera output and to record who enters. An in-house remote control 98 may to raise or lower the posts 11-13.

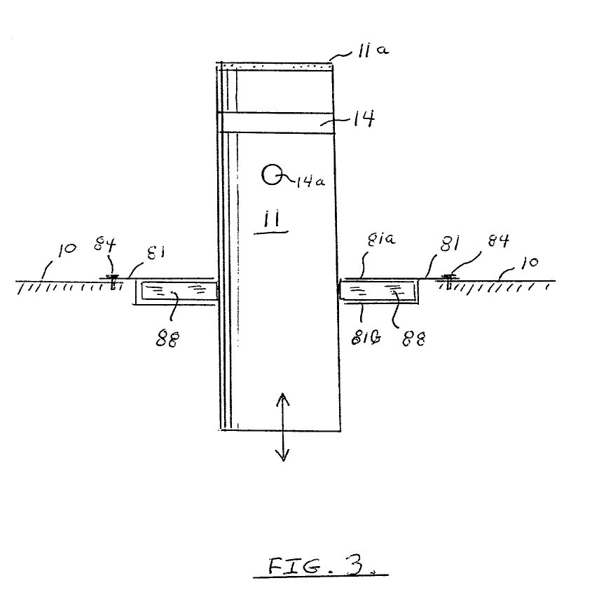

FIG. 3 shows the construction of the various upper flange and seal assemblies.

For example, flange 81 comprises an upper deck 81a and a lower deck 81b. A seal 88, for contacting the post 11, is positioned within the flange 81. Bolts 84 are utilized to attach the flange 81 to the driveway surface 10.

Thus, post 11 may move up and down while still preserving the integrity of the lower system elements.

As further shown in FIG. 3, the posts may include a secondary light 14a for safety purposes. The top portion of post 11 is shown as having a painted layer 11a to match the driveway surface color and the flange color. Thus, in the down position, the posts are virtually invisible.

The posts 12 and 13 and the flanges 82 and 83 have a similar construction to that shown in FIG. 3.

While a particular gate system and method of operation have been shown and described, it is intended in this specification to broadly cover all equivalent gating systems and methods.

For example, the pumping means may be located within the casing to reduce the number of flow lines required.

The invention is further defined by the claims appended hereto.

We claim:

1. A gate or blocking system for a driveway or other area comprising:
at least one post (11) of about 18-36 inches in length installed in an underground location, drive means (50, 51, 52) for moving said post vertically upwardly to a blocking position, in-ground structure comprising a cylinder (21) and an outer casing (31) and a chamber (71), said in-ground structure (21, 31, 71) providing means whereby said post (11) is guided and driven to an upper blocking position.

2. The gate system of claim 1 and further including second and third posts (12, 13) which are also driven to an upper blocking position for a driveway or other area.

3. The gate system of claim 2 wherein each of said posts (11, 12, 13) has lighting means (14, 15, 16) positioned thereon for providing a warning and safety feature.

4. The gate system of claim 3 wherein pressure sensor means (90) are positioned adjacent said posts (11, 12, 13) to prevent damage to a vehicle stopped over said posts.

5. The gate system of claim 4 wherein said drive means for moving said posts includes a hydraulic splitter unit (60) for dividing fluid into three parallel paths (61, 62, 63).

6. The gate system of claim 5 and further including a remote control operator (95) for use in a vehicle, a remote control operator (98) for in-house usage and a camera (96) means for viewing the area around said posts.

7. The gate system of claim 6 including ground-level flange and seal units (81, 82, 83) which surround and seal said posts in operation to preserve the integrity of the lower, in-ground operating system.

8. A method of blocking a driveway or other area comprising the steps of:
a) providing at least one post which stands vertically in an underground location,
b) providing drive means for moving said post to an above-ground position when desired,
c) moving said post to an above-ground and blocking position.
